(19) United States
(12) Patent Application Publication
(10) Pub. No.: US 2013/0257985 A1
(43) Pub. Date: Oct. 3, 2013

(54) PRINTING DEVICE AND PRINTING METHOD

(71) Applicant: SEIKO EPSON CORPORATION, Tokyo (JP)

(72) Inventors: Mika FUJIMORI, Shiojiri (JP); Naoki SUDO, Shiojiri (JP); Bunji ISHIMOTO, Matsumoto (JP)

(73) Assignee: SEIKO EPSON CORPORATION, Tokyo (JP)

(21) Appl. No.: 13/853,606

(22) Filed: Mar. 29, 2013

(30) Foreign Application Priority Data
Apr. 2, 2012 (JP) 2012-083942

(51) Int. Cl. B41J 11/00

(52) U.S. Cl. CPC B41J 11/008
USPC 347/37

(57) ABSTRACT

A printing device which prints on a printing medium comprising: a printing head; a control section which moves the printing head in a scanning direction and relatively moves either one of the head or the printing medium in a direction which intersects the scanning direction; and a discharge control section, wherein the printing head is provided with a plurality of color nozzle rows which are arranged to line up in an intersecting direction and the plurality of nozzles, which discharge color ink of the same color, are arranged in the intersecting direction for each color nozzle row, and a black ink nozzle row which is a nozzle row, which is arranged to line up with the color nozzle rows and where black ink is discharged, and which has a black ink nozzle group of the same number as the number of rows of the color ink.

### CROSS-REFERENCE TO RELATED APPLICATIONS

This application claims priority to Japanese Patent Application No. 2012-083942 filed on Apr. 2, 2012. The entire disclosure of Japanese Patent Application No. 2012-083942 is hereby incorporated herein by reference.

### BACKGROUND

1. Technical Field

The present invention relates to a printing device and a printing method where printing is performed using color ink and black ink.

2. Background Technology

In the past, dots have been formed in a printing image in a printing device by discharging ink from nozzles to match movement of a printing head. In addition, a printing device is known which discharges each ink at each scan of an outgoing path and a return path in order to increase printing speed when the printing head is moved to reciprocate in a main scanning direction (for example, refer to Patent Documents 1 and 2).

In addition, a printing device is known which is provided with a printing head where color ink nozzle rows which discharge color ink and black ink nozzle rows which discharge black ink are arranged to line up in a transport direction of a sheet of paper. It is possible for the color ink nozzles and the black ink nozzle rows, which are a number according to a feeding amount of the medium, to form a dot row of a predetermined width at the same time in such a printing device (for example, refer to Patent Document 3).

Japanese Laid-open Patent Publication No. 2002-307671 (Patent Document 1), Japanese Laid-open Patent Publication No. H5-318770 (Patent Document 2), and Japanese Laid-open Patent Publication No. H7-237346 (Patent Document 3) are examples of the related art.

### SUMMARY

### Problems to be Solved by the Invention

Printing deviations occur due to deviations in recording positions of the dots in the outgoing path and a recording position of the dots in the return path in reciprocating printing. In addition, printing control is not particularly easy with black ink compared to printing with color ink due to vertical alignment of the dot rows.

The invention has been made in view of the problems described above and has an advantage to provide a printing device and a printing method where a high standard of image quality of printing materials is maintained in the printing device where reciprocating printing is performed.

### Means used to Solve the Above-Mentioned Problems

In order to solve the problem described above, the invention has a printing head, a control section which moves the printing head in a scanning direction and relatively moves either one of the head or a printing medium in a direction which intersects the scanning direction, and a discharge control section, wherein the printing head is provided with a plurality of color nozzle rows which are arranged to line up in an intersecting direction and the plurality of nozzles, which discharge color ink of the same color, are arranged in the intersecting direction for each color nozzle row, and a black ink nozzle row which is a nozzle row, which is arranged to line up with the color nozzle rows and where black ink is discharged, and which has a black ink nozzle group of the same number as the number of rows of the color ink, and the black ink nozzle group forms dots by allocating each black ink nozzle group which is arranged to line up with each color ink nozzle row such that the recording sequence of the color dots and the black dots, which are recorded in an adjacent region where dots are recorded on the medium, is not the same.

In the invention which is configured as described above, in a printing head where each nozzle row is vertically aligned, the same printing head discharges ink from each of color ink nozzles of each color and black ink nozzles which are arranged to line up with the same color ink nozzles in each scan of an outgoing path and a return path in an orthogonal direction to a transport direction of the medium due to a head driving section. At this time, the nozzle rows which discharge black ink record by dividing each of the nozzle rows which are set in accordance with the color ink nozzles of each color such that the recording sequence of the color dots and the black dots in an adjacent region where dots are recorded on the medium is not the same. Here, the recording sequence of the color dots and the black dots has a meaning of a sequence where black dots are recorded with regard to the medium. As a result, the recording sequence of the color dots and the black dots changes for every dot, and it is possible to make it difficult to see printing deviations.

### BRIEF DESCRIPTION OF THE DRAWINGS

Referring now to the attached drawings which form a part of this original disclosure:

FIG. 1 is a block configuration diagram which describes a printing device according to the invention;

FIG. 2 is a block configuration diagram which describes the printing device according to the invention;

FIG. 3 is an image diagram which describes an arrangement of each nozzle row of a printing head 8;

FIG. 4 is a diagram which describes a printing image which is printed by a printer 1;

FIG. 5 is a diagram which describes a relationship between scanning of the printing head 8 and a region where dots are recorded;

FIGS. 6A and 6B are diagrams which describe a boundary of dot rows;

FIG. 7 is a flow chart which describes an embodiment of the printing device;

FIGS. 8A to 8D are diagrams which describe generation of raster data; and

FIGS. 9A to 9C are diagrams which describe a state where dot rows of a predetermined width, which is continuous in the transport direction of a sheet of paper, are recorded.

### DETAILED DESCRIPTION OF EXEMPLARY EMBODIMENTS

### 1. First Embodiment

Below, a printing device according to the invention will be described.

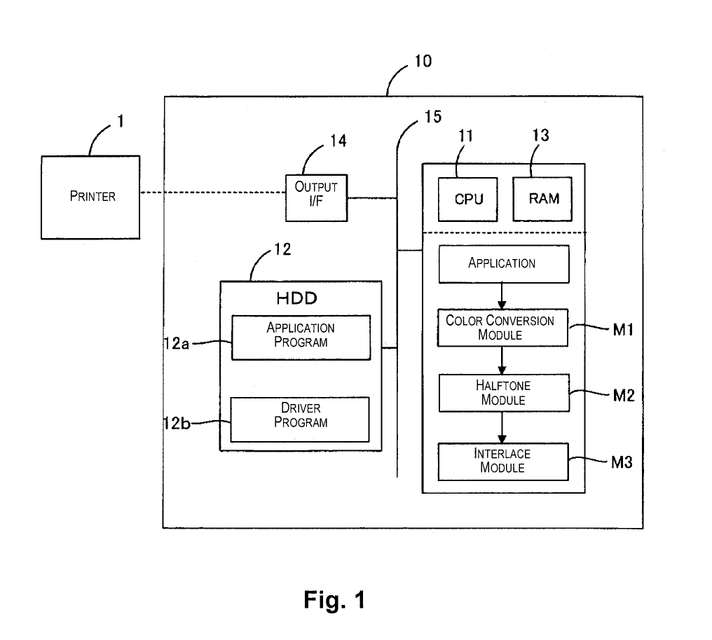

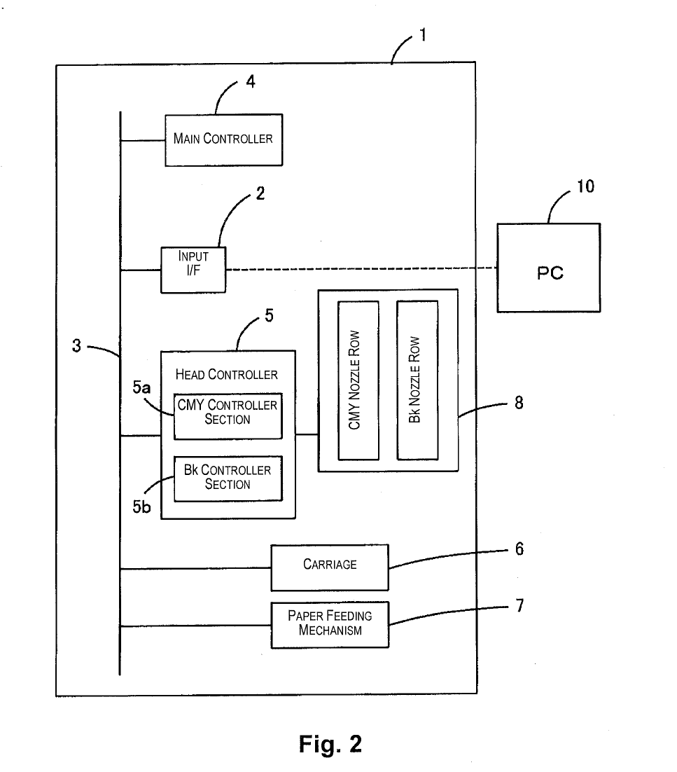

FIG. 1 is a block configuration diagram which describes a printing device according to the invention. FIG. 2 is a block configuration diagram which describes the printing device according to the invention. In FIG. 1, a printer 1 and a personal computer 10 are connected via a network or a cable, and the entirety broadly functions as the printing device.

The personal computer 10 (also described below as a PC) is configured to be provided with a CPU (Central Processing Unit) 11, an HDD (Hard Disk Drive) 12, a RAM (Random Access Memory) 13, and an output I/F 14. In addition, each section is connected via a bus 15, and driving is performed based on integrated control of the CPU 11. Furthermore, the PC 10 is connected to the printer 1 via the output I/F 14, and it is possible to output various types of data to the printer 1 through the output I/F 14.

The CPU 11 executes an application program 12a and a driver program 12b which are recorded on the HDD 12 based on the operation of an operating system. The application program 12a executes the function of various types of applications with regard to the CPU 11. As an example of this, the application program 12a generates image data according to an operation input of a user in the CPU 11.

The driver program 12b generates printing data in order to control printing in the CPU 11. The printing data is configured to include raster data (which will be described later) which is formed based on image data, and a control command for executing a printing process in the printer 1. Therefore, the CPU 11 functions as a color conversion module M1, a halftone module M2, and an interlace module M3 in order to generate printing data using the functions of the driver program 12b. Here, the color conversion module M1 converts the image data, which is generated using an application, into ink amount data which indicates the amount of ink to be used. In addition, the halftone module M2 converts the ink amount data into binarized dot data. Then, the interlace module M3 converts alignment data which is configured by dot data into raster data according to the ink amount which is output by a first main scan of the printer 1. The raster data is data which is recorded by one paper feeding.

As shown in FIG. 2, the printer 1 is connected to the PC 10 via an input interface (I/F) 2. In addition, the input I/F 2 is connected to a bus 3, and the bus 3 is further connected to a main controller 4, a head controller 5, a carriage 6, a paper feeding mechanism 7, and a printing head 8.

The main controller 4 is configured by, for example, an ASIC (Application Specific Integrated Circuit), and is provided with a CPU as a calculation section and a RAM as an internal memory. The main controller 4 controls a printing process by driving each section based on printing data when the printing data is received from the PC 10 through the input I/F 2.

The head controller 5 is provided with a CMY controller section 5a for CMY which is color ink and a Bk controller section 5b for Bk which is black ink. Then, the printing head 8 which is provided with a color ink nozzle row and a black ink nozzle row is connected to the head controller 5, the color ink nozzle row is controlled by the CMY controller section 5a, and a black ink nozzle row is controlled by the Bk controller section 5b.

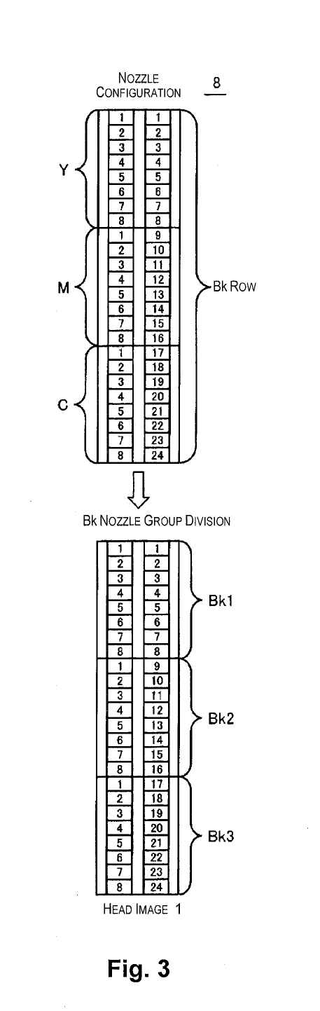

FIG. 3 is an image diagram which describes an arrangement of each nozzle row of the printing head 8. In FIG. 3, the left side is the color ink nozzle row, and the right side is the black ink nozzle row. In addition, an alignment direction of nozzles which are given a number is a direction where paper is transported (also described below as a sub-scanning direction). Then, a direction which is arranged to line up the color ink nozzle row and the black ink nozzle row is a direction which intersects the sub-scanning direction (also described below as the main scanning direction).

The color ink nozzle row is configured by a row C which discharges C (cyan) ink, a row M which discharges M (magenta) ink, and a row Y which discharges Y (yellow) ink. Specifically, three regions of leading edge, middle, and a tail end from the upper side of the diagram are respectively allocated in order of YMC. In addition, each color nozzle row is configured by M nozzles and configures each nozzle row of the row C, the row M, and the row Y.

The Bk ink nozzle row is arranged to line up with the color ink nozzle row in the main scanning direction. In the present embodiment, each Bk nozzle row is configured by the same number of nozzles as the total number of nozzles of color ink (that is, N×M=3M). Here, in the diagram, the Bk ink nozzles and the color ink nozzles are set in accordance with the same position in the main scanning direction but are not limited to this. For example, the Bk ink nozzles and the color ink nozzles can be disposed by being deviated by a predetermined distance in the sub-scanning direction (that is, zigzag shaped).

In addition, the Bk ink nozzles and the color ink nozzles are formed in a group according to an alignment position. Essentially, since the color ink nozzle rows are allocated color ink with colors which are each different, there are the Y row, the M row, and the C row, and one row where black ink is allocated is just the Bk row. However, the BK row is divided into groups of a Bk1 row, a BK2 row, and a Bk3 row to correspond to the color ink of each color also in order to make printing control easy. In this manner, the Bk ink nozzle rows described above are divided into groups by being divided into three regions which are adjacent to the nozzle rows of each of the colors (C, M, and Y) when the color ink described above is three colors, and printing is performed in each region as described later.

Then, the carriage (head driving section) 6 is a mechanism where the printing head 8 is moved to reciprocate in the main scanning direction. The carriage 6 is fixed to the printing head 8, and moves the printing head 8 in an outgoing path direction or a return path direction according to the driving of a carriage motor which is not shown in the diagram. Here, the printer 1 performs reciprocating printing where each ink is discharged in the scanning (outgoing path and return path) of the printing head 8. Then, recording using ink is performed in the outgoing path and return path using ink rows which belong to each group which are each described above.

The paper feeding mechanism 7 transports the paper in units of predetermined distances. The paper feeding mechanism 7 is a mechanism which is provided with a transport roller and a paper feed motor which drives the transport roller and is disposed in a transport path inside the printer 1. In addition, in the present embodiment, the paper feeding mechanism 7 only transports paper the same distance as the nozzle rows of the color ink in one paper feeding. That is, the paper feeding mechanism 7 transports the paper in units of M dots in a case where each nozzle row of C, M, and Y are configured of M nozzles.

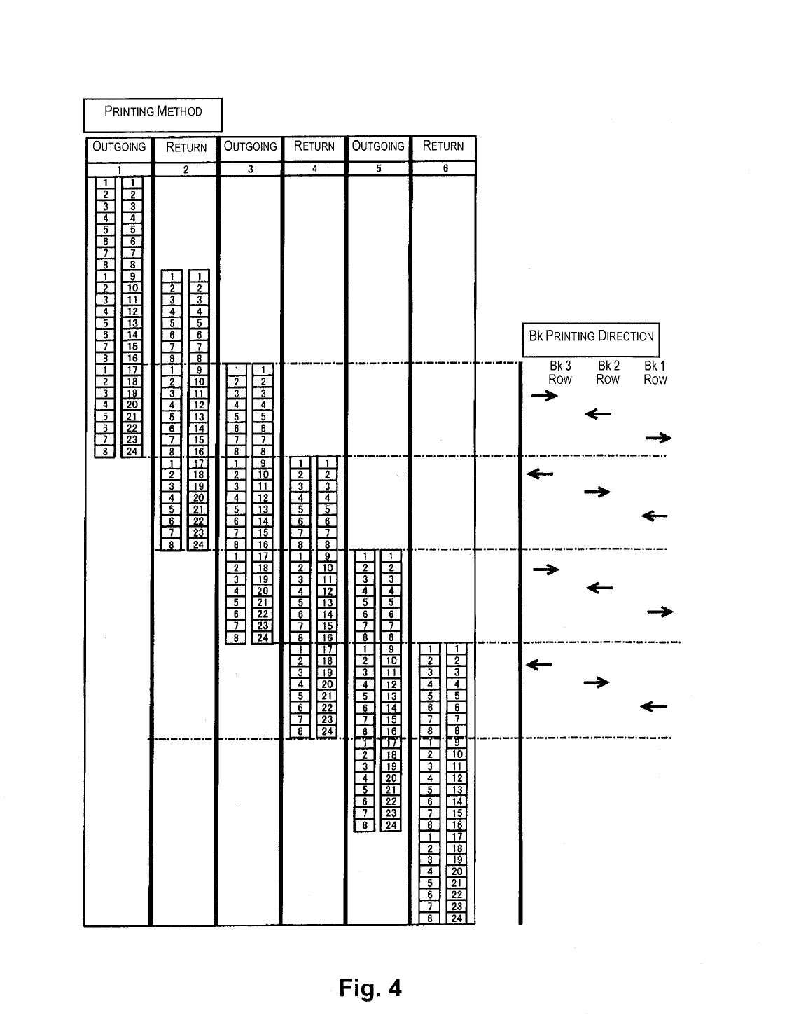

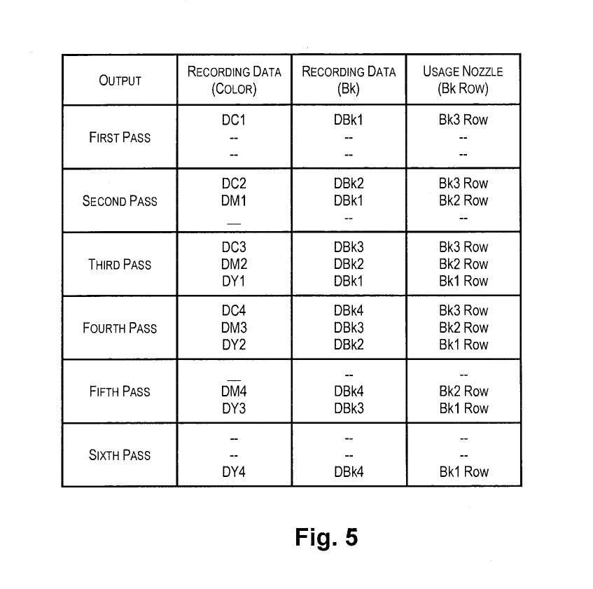

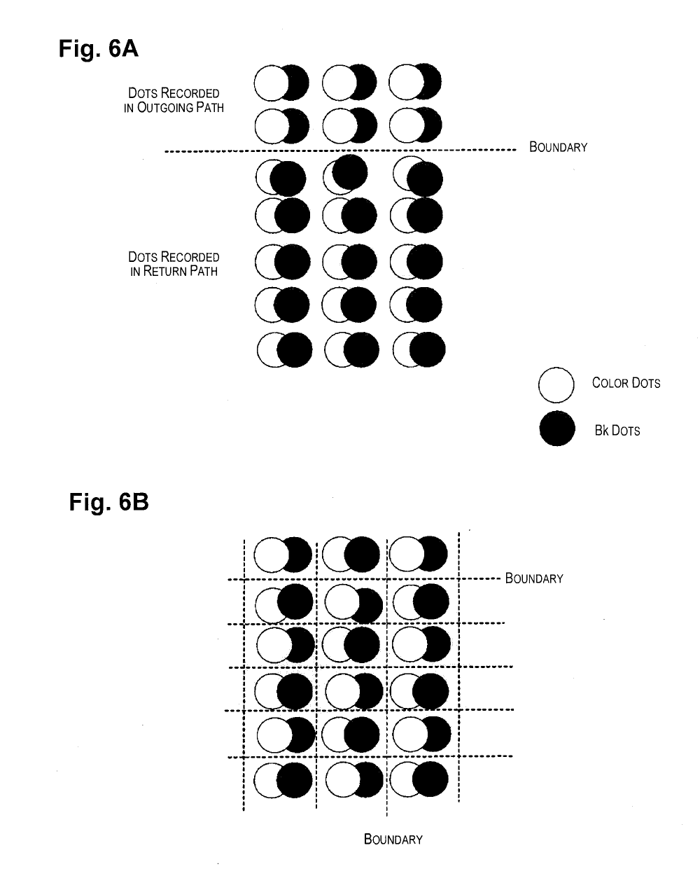

FIG. 4 is a diagram which describes a printing image which is printed by the printer 1. In addition, FIG. 5 is a diagram which describes a relationship between scanning of the printing head 8 and a region where dots are recorded. Then, FIGS. 6A and 6B are diagrams which describe a boundary of dot rows. In order to make the description easy in FIG. 5, recording regions on the paper are regulated into four for each color, and data of each color which is recorded in each region is set as DCi, DMi, DYi, and DBki (i: 1-4). In addition, in order to make the description easy in FIGS. 6A and 6B, the color dots are recorded using the same color.

FIG. 4 is shown as an image where the printing head 8 relatively gradually lowers in order to transport paper using the paper feeding mechanism 7 upward in the diagram. The printing head 8 reciprocates along the main scanning direction using the carriage 6, and each one scan is the outgoing path or the return path. In addition, as shown in the diagrams, the paper is transported to the extent which is equivalent to the height of each color nozzle row. That is, paper feeding is performed which is equivalent to the length of the nozzle rows of each color in the color ink nozzle row described above with regard to one scanning of the outgoing path or the return path. For convenience, from the left of the diagram, the outgoing path, the return path, the outgoing path, the return path, the outgoing path, and the return path are described, and are referred to as a first pass, a second pass, a third pass, a fourth pass, a fifth pass, a sixth pass . . . and a Kth pass.

As described above, the recording sequence of the color dots (C, M, Y) and the Bk dots of the dots which are formed is different in the outgoing path and the return path in a case where the ink is recorded by the printing head 8 being reciprocally scanned. That is, the recording sequence of the Bk dots and the color dots is in one scan of the outgoing path, and the recording sequence of the color dots and the Bk dots is in one scan of the return path in order to set in accordance with the color nozzles rows and the Bk nozzle rows in the main scanning direction. It is natural that the recording sequence of the Bk dots in each scanning direction is different since the color dots are recorded so as to overlap in this state even in a case where other color dots are recorded in the same region.

In such a case, there are cases where it is easy to see printing irregularities of the dots at the boundary of a region where the recording sequence of the color dots and the Bk dots is different. The printing irregularities are generated since dots are not recorded at the correct position, and are caused by variation of the paper feeding amount of the paper feeding mechanism 7 and variation in landing positions of ink in the outgoing path and the return path. In addition, the printing irregularities become more conspicuous as the width in the paper feeding direction of the dot rows increases. For example, the change in the recording sequence is obvious to the eye in the vicinity of a boundary of the dot row in FIG. 6A in a case where the dot rows which are formed in the outgoing path and the dot rows which are formed in the return path share a predetermined width. In particular, the printing irregularities in the vicinity of the boundary are less obvious to the eye in the Bk dots.

Therefore, in the invention, each dot is recorded by dividing into Bk3, Bk2, and Bk1 rows such that the recording sequence of the color dots and the Bk dots in an adjacent region where dots are recorded on the medium, is different as shown in 6(b). Specifically, when referring to FIG. 4, just the C row and the Bk3 row enter the printing region in the first pass. Then, FIG. 5 shows recording of dots on DC1 and DBk1. It is natural that DC1 for printing color dots is printed by the C row, but it is shown that any one of the Bk1 row, the Bk2 row, or the Bk3 row can be used with regard to recording of DBk1. Here, Bk1 for the first pass my use the Bk3 row, but not all dots are recorded by the Bk3 row and only predetermined dots are recorded by the Bk3 row.

The second pass is the return path, and the C row, the M row, the Bk2 row, and the Bk3 row enter the printing region in the second pass. Then, with regard to the color ink, DC2 is printed using the C row, and DM1 is printed using the M row in order for DC1 to finish printing. On the other hand, with regard to the black ink, the Bk3 row uses the same nozzle as the first pass and records DBk2. Also at this time, not all the dots are recorded by the Bk3 row. On the other hand, dots are recorded which are not recorded by the Bk3 row in DBk1 by using a predetermined nozzle in the Bk2 row. At this time, the recording sequence of the color dots and the Bk dots is different between the regions which are adjacent due to the dots which are recorded by the Bk2 row being adjacent to the dots which are recorded by the Bk3 row.

Then, the third pass is the return path, and the C row, the M row, the Y row, the Bk2 row, the Bk3 row, and the Bk1 row enter the printing region in the third pass. Then, with regard to the color ink, DC3 is recorded with the C row, DM2 is recorded with the M row, and DY1 is recorded with the Y row. On the other hand, with regard to the black ink, DBk2 is recorded in the Bk3 row. In addition, DBk2 is recorded in the Bk2 row. Then, dots which are not recorded in DBk1 by the Bk3 row and the Bk2 row are recording by using a predetermined nozzle in the Bk1 row. That is, all target dots of DBk1 are recorded due to the printing head 8 moving three times (the outgoing path, the return path, and the outgoing path). In addition, the recording sequence of the dots is different between the regions which are adjacent due to the dots which are recorded by the Bk1 row being adjacent to the dots which are recorded by the Bk2 row and not being adjacent to the dots which are recorded by the Bk3 row.

With such a configuration, the recording sequence of the color dots and the Bk dots changes for each region where one dot is formed when a dot row of a certain dot width is recorded. As a result, it is possible for it to be difficult to see printing irregularities which are generated at the dot boundary without enlarging the dot rows which configure the boundary. Furthermore, it is possible for it to be difficult to see printing irregularities in the main scanning direction since the recording sequence of the color dots and the Bk dots changes in each region where one dot is formed in the main scanning direction.

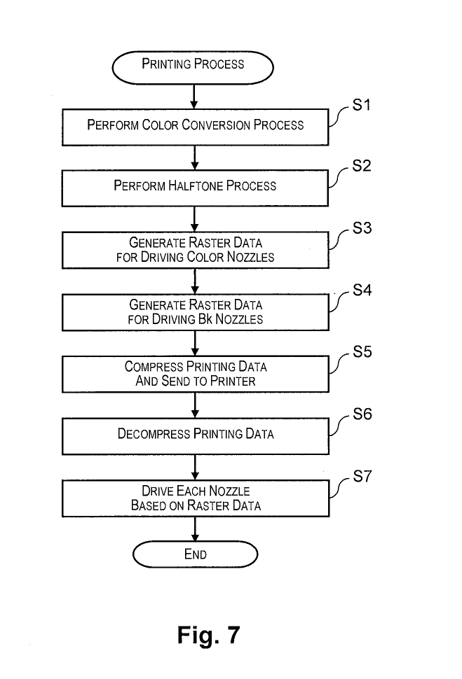

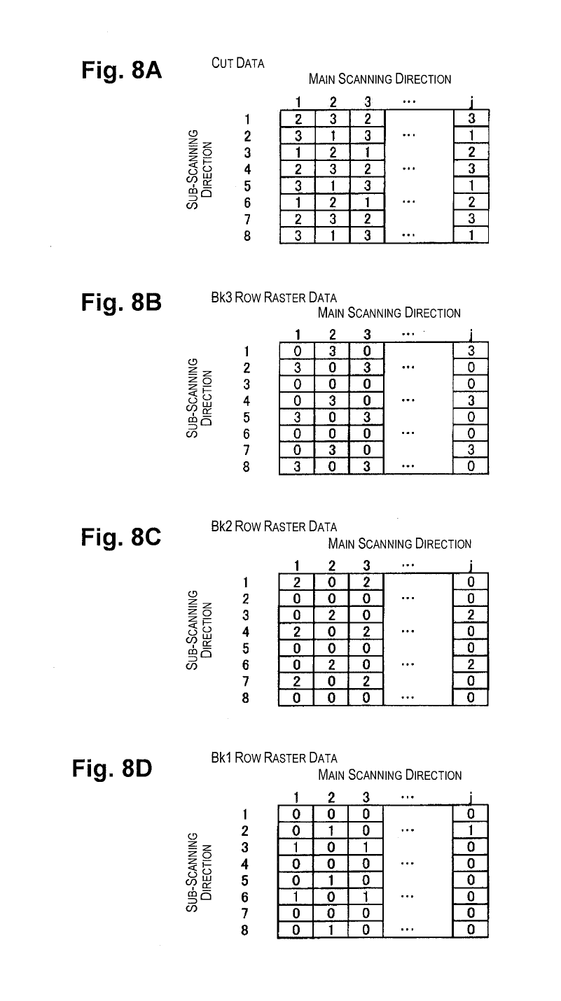

Next, an embodiment of the printing device will be described. FIG. 7 is a flow chart which describes an embodiment of the printing device. In addition, FIGS. 8A to 8D are diagrams which describe generation of raster data.

In this embodiment, description will be performed with a case where a solid Bk image is recorded by being added to the color image as printing data as an example. In addition, the printing process shown in FIG. 7 begins by issuing a printing command in an application which is executed by the PC 10

In step S1, the color conversion module M1 of the PC 10 is converted from the color component values of R, G, B in image data which includes printing data into ink amount data which is formed from each color component value of C, M, Y, and K. The color conversion module M1 performs the color conversion process using an image conversion LUT where a correspondence relationship between each component value of R, G, and B and each component value of C, M, Y, and K, is recorded.

In step S2, the halftone module M2 of the PC 10 binarizes the ink amount data and converts the ink amount data to dot data which corresponds to the on and off of the discharging of ink droplets by each nozzle. The dot data is data which is configured by aligning data (for example, “1” and “0”), which indicates on and off of dots according to the resolution of the printing image, vertically and horizontally. After the halftone process, dot data is generated on the four planes of C, M, Y, and K which match the nozzle density.

In step S3, the interlace module M3 generates raster data which is necessary to drive the color ink nozzles of the printing head 8. In order to make the description easy in the present embodiment, the printing head 8 is set to record with color ink using eight nozzles which configure each color nozzle row. As a result, the interlace module M3 acquires raster data of eight alignment portions from dot data. In addition, raster data of color dots is generated for each color of C, M, and Y.

In step S4, the interlace module M3 generates raster data which is necessary to drive the Bk ink nozzles of the printing head 8. The printer 1 records a plurality of Bk dots which are continuously recorded in a certain region by dividing three ways to the Bk3 row, the Bk2 row, and the Bk1 row. As a result, the interlace module M3 generates raster data according to the disposing of dot rows which are recorded by the Bk3 row, the Bk2 row, and the Bk1 row.

The data which is shown in FIGS. 8A to 8D is aligned with j (where j is an even number) in the main scanning direction, and is just aligned with k (k=8 in the diagram) in the sub-scanning direction. In addition, data for each one nozzle in the raster data is specified by the alignment coordinates (j, k). Then, Bk ink nozzle rows, the Bk3 row, the Bk2 row, and the Bk1 row, which record dots using each piece of data respectively are indicated by “3”, “2”, and “1”.

Each piece of data (j, k) is necessary to perform recording using nozzle rows which are different in the main scanning direction and the sub-scanning direction in order that the recording sequence of the color dots and the Bk dots is not the same in the adjacent data alignment. That is, in FIG. 8(a) the data (8, 1), (8, 3), . . . (8, k-1), (7, 2), (7, 4) . . . (7, k), (5, 1), (5, 3), . . . (5, k-1), (4, 2), (4, 4) . . . (4, k), (2, 1), (2, 3), . . . (2, k-1), (1, 2), (1, 4) . . . and (1, k) is necessary with recording using the Bk3 row. In addition, the data (7, 1), (7, 3), . . . (7, k-1), (6, 2), (6, 4) . . . (6, k), (4, 1), (4, 3), . . . (4, k-1), (3, 2), (3, 4) . . . (3, k), (1, 1), (1, 3), . . . (1, k-1) is necessary with recording using the Bk2 row. Then, the data (8, 2), (8, 4), . . . (8, k), (6, 1), (6, 3) . . . (6, k-1), (5, 2), (5, 4), . . . (5, k), (3, 1), (3, 3), . . . (3, k-1), (2, 2), (2, 4), and . . . (2, k) is necessary with recording using the Bk1 row.

As a result, as one example of the interlace module M3 generating raster data, raster data is generated by a mask process using the Bk3 row, the Bk2 row, and the Bk1 row. That is, the interlace module M3 extracts raster data which is recorded by the Bk3 row using the mask for the Bk3 row in the data of j×k which is cut out from the dot data as shown in FIG. 8B. In a similar manner, the interlace module M3 extracts raster data which is recorded using each of the nozzles of the Bk2 row and Bk1 row from the data of the eight dot row width using the mask as shown in FIG. 8C and FIG. 8D. This raster data for the Bk3 row, the Bk2 row, and the Bk1 row which are extracted is rearranged according to a timing of a usage nozzle of the printing head 8.

In step S5, the CPU 11 supplies raster data when compressed as printing data to the printer 1 through the output I/F 14 of the PC 10.

In step S6, the main controller 4 of the printer 1 receives the printing data which is compressed from the PC 10 and decompresses the printing data.

In step S7, the main controller 4 outputs'each piece of raster data of C, M, and Y to the CMY controller section 5a, and outputs the Bk raster data to the Bk controller section 5b. As a result, the CMY controller section 5a generates a CMY driving signal in order to drive the nozzles based on raster data of each color and drives the nozzle rows of each color. A dot row with an eight dot width is driven by the CMY controller 5a driving the color nozzles which correspond to the color which is specified by the raster data since the color nozzle raster data supplies an eight dot row portion at the same time for each color.

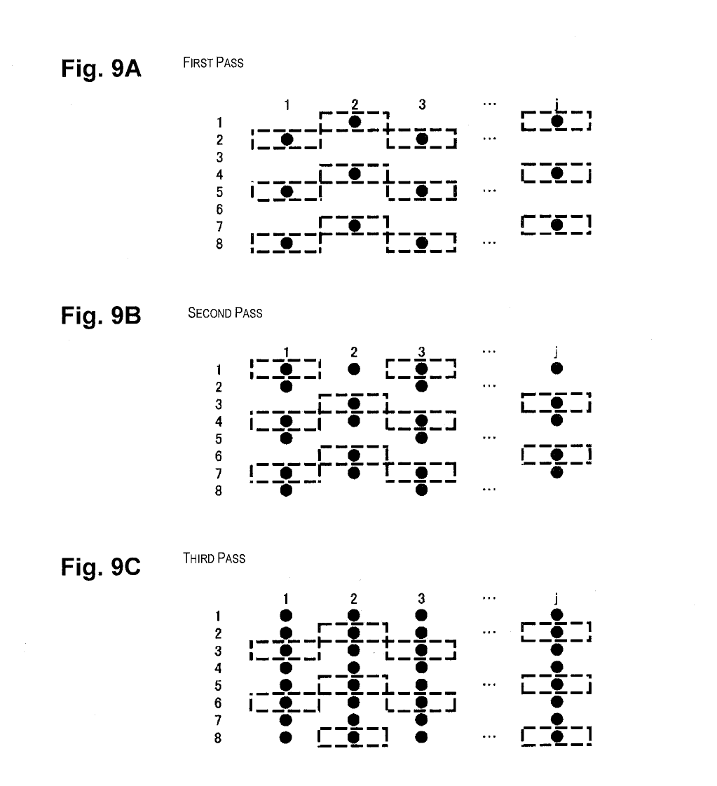

On the other hand, the Bk controller section 5b drives the Bk ink nozzle by generating a Bk driving signal in order to drive the nozzle rows based on raster data for each row as shown in FIGS. 8A to 8D. FIGS. 9A to 9C are diagrams which describe a state where dot rows of j×8, which are continuous in the transport direction of a sheet of paper, are recorded. Here, only the Bk dots are described and the color dots are not described in order to make the description easy in FIGS. 9A to 9C. The diagram shows dots which are recorded by the dots which are enclosed by the dotted line as the corresponding pass.

As shown in FIG. 9A, each Bk dot of (8, 1), (8, 3), . . . (8, k-1), (7, 2), (7, 4) . . . (7, k), (5, 1), (5, 3), . . . (5, k-1), (4, 2), (4, 4) . . . (4, k), (2, 1), (2, 3), . . . (2, k-1), (1, 2), (1, 4) . . . and (1, k) is recorded in the first pass using recording of an (8-1)^{th} dot row of the C ink and the Bk3 row by matching the movement in the outgoing path direction of the printing head 8. Next, as shown in FIG. 9B, each dot of (7, 1), (7, 3), . . . (7, k-1), (6, 2), (6, 4) . . . (6, k), (4, 1), (4, 3), . . . (4, k-1), (3, 2), (3, 4) . . . (3, k), (1, 1), (1, 3), . . . and (1, k-1) is recorded in the second pass using recording of an (8-1)^{th} dot row of the M ink and the Bk2 row by matching the movement in the return path direction of the printing head 8. Then, as shown in FIG. 9(c), recording of (8, 2), (8, 4), . . . (8, k), (6, 1), (6, 3) . . . (6, k-1), (5, 2), (5, 4), . . . (5, k), (3, 1), (3, 3), . . . (3, k-1), (2, 2), (2, 4), . . . and (2, k) is performed in the third pass using recording of an (8-1)^{th} dot row of the Y ink and the Bk1 row by matching the movement in the outgoing path direction of the printing head 8.

As a result, the color ink records j×k dots in the first scanning. On the other hand, the Bk ink forms j×k dots which are continuous in a certain region in the third scanning. At this time, with regard to the Bk dots, it is possible for it to be difficult to see printing irregularities since the recording sequence of the color ink and the Bk ink is different in each region where the dots are recorded.

As described above, according to the invention, it is possible change the recording sequence of color dots and black dots for each predetermined dot row and for it to be difficult to see printing deviations by since dot rows in the scanning direction which is different for each predetermined dot row width are formed.

### 2. Other Embodiments

A timing where the raster data of each of the Bk3 row, the Bk2 row, and the Bk1 row is generated can be realized using the printer 1. In this case, first, the PC 10 sends data of a predetermined number of dots from the dot data to the printer 1. Then, the main controller 4 of the printer 1 generates raster data using a method in a similar manner to the interlace module M3. Using the configuration described above, it is possible for the invention to be applied to the printer 1 even with regard to any type of printing data which is supplied from the PC 10.

In addition, the configuration of the printing device using the printer 1 and the PC 10 is one example, and the printing device can be realized using a single unit of the printer 1.

Then, using the Bk ink nozzle rows by dividing into N according to the number of colors N of the color ink is one example, and it is possible to appropriately modify the nozzle used in the scope where the printing irregularities are not conspicuous in the printing image.

Here, of course, the invention is not limited to the embodiment described above. That is, applying by modifying an appropriate combination of a member and a configuration or the like which are able to be substituted with each other and which are disclosed in the embodiment described above, appropriately substituting the member and the configuration or the like which are able to be substituted with the member and the configuration or the like which are disclosed in the embodiment described above and are a known technology, further applying modification of the combination thereof, appropriately substituting the member and the configuration or the like which a person skilled in the art could obtain by assuming as a substitution of the member and the configuration or the like which are disclosed in the embodiment described above based on a known technology or the like, and further applying modification of the combination thereof are disclosed as embodiments of the invention.

What is claimed is:

1. A printing device which prints on a printing medium comprising:
a printing head;
a control section which moves the printing head in a scanning direction and relatively moves either one of the head or the printing medium in a direction which intersects the scanning direction; and
a discharge control section,
wherein the printing head is provided with, a plurality of color nozzle rows which are arranged to line up in an intersecting direction and the plurality of nozzles, which discharge color ink of the same color, are arranged in the intersecting direction for each color nozzle row, and a black ink nozzle row which is a nozzle row, which is arranged to line up with the color nozzle rows and where black ink is discharged, and which has a black ink nozzle group of the same number as the number of rows of the color ink, and
the black ink nozzle group forms dots by allocating each black ink nozzle group which is arranged to line up with each color ink nozzle row such that the recording sequence of the color dots and the black dots, which are recorded in an adjacent region where dots are recorded on the medium, is not the same.

2. The printing device according to claim 1,
wherein each color ink nozzle row is configured by M nozzles with a number of colors of the color ink as N, and
the black ink nozzle rows are configured with N×M nozzles.

3. The printing device according to claim 1,
wherein a transport distance of the medium is for each of the number of nozzles in each of the color ink nozzle rows.

4. A printing method using the printing device which prints on a printing medium and is provided with a printing head, a control section which moves the printing head in a scanning direction and relatively moves either one of the head or the printing medium in a direction which intersects the scanning direction, and a discharge control section, where the printing head is provided with a plurality of color nozzle rows which are arranged to line up in an intersecting direction and the plurality of nozzles, which discharge color ink of the same color, are arranged in the intersecting direction for each color nozzle row, and a black ink nozzle row which is a nozzle row, which is arranged to line up with the color nozzle rows and where black ink is discharged, and which has a black ink nozzle group of the same number as the number of rows of the color ink, the method comprising:
forming dots using the black ink nozzle group by allocating each black ink nozzle group which is set in accordance with each color ink nozzle row such that the recording sequence of the color dots and the black dots, which are recorded in an adjacent region where dots are recorded on the medium, is not the same.
